(19) United States
(12) Patent Application Publication
(10) Pub. No.: US 2017/0013456 A1
(43) Pub. Date: Jan. 12, 2017

(54) METHOD AND DEVICE FOR TESTING A TERMINAL

(71) Applicant: Xiaomi Inc., Beijing (CN)

(72) Inventors: Yanlu ZHANG, Beijing (CN); Enxing HOU, Beijing (CN); Ziguang GAO, Beijing (CN)

(73) Assignee: Xiaomi Inc.

(21) Appl. No.: 15/200,810

(22) Filed: Jul. 1, 2016

(30) Foreign Application Priority Data
Jul. 10, 2015 (CN) 201510406133.3

(51) Int. Cl. H04W 12/06; H04W 76/02; H04L 29/06; H04W 8/00; H04W 52/02; H04W 12/08; H04W 24/06; H04W 8/24

(52) U.S. Cl. CPC H04W 12/06; H04W 24/06; H04W 76/02; H04W 8/24; H04W 8/005; H04W 52/0206; H04W 12/08; H04L 63/083; H04L 63/10

(57) ABSTRACT

A method for testing a terminal includes establishing a connection with a preset device when a preset trigger condition is detected, starting an automatic detection program to obtain an automatic detection result, and sending the automatic detection result to the preset device.

### CROSS-REFERENCE TO RELATED APPLICATIONS

This application is based on and claims priority to Chinese Patent Application No. 201510406133.3, filed Jul. 10, 2015, the entire contents of which are incorporated herein by reference.

### TECHNICAL FIELD

The present disclosure generally relates to the field of computer technology and, more particularly, to a method and a device for testing a terminal.

### BACKGROUND

In related art, with the development of computer technology and wireless communication technology, more and more electronic devices are equipped with a wireless communication module. For example, many smart mobile phones and tablet computers have wireless communication capabilities. Wireless communication technology is also widely used in the field of smart terminals, smart homes, etc. Before an electronic device is delivered by a manufacturer, a test technician typically tests the hardware and software components of the electronic device, so as to ensure that the electronic device functions normally.

### SUMMARY

Embodiments of the present disclosure provide a method and a device for testing a terminal.

According to a first aspect of the embodiments of the present disclosure, there is provided a method for testing a terminal, for use in a device under test. The method includes establishing a connection with a preset device when a preset trigger condition is detected. The method also includes starting an automatic detection program to obtain an automatic detection result. The method further includes sending the automatic detection result to the preset device.

According to a second aspect of the embodiments of the present disclosure, there is provided a device for testing a terminal, which is for use in a device under test. The device includes a processor and a memory configured to store instructions executable by the processor. The processor is configured to execute the instructions to establish a connection with a preset device when a preset trigger condition is detected. The processor is also configured to execute the instructions to start an automatic detection program to obtain an automatic detection result. The processor is further configured to execute the instructions to send the automatic detection result to the preset device.

According to a third aspect of the embodiments of the present disclosure, there is provided a non-transitory computer readable storage medium having stored therein instructions that, when executed by a processor of a device under test, cause the device under test to perform a method for testing a terminal. The method includes establishing a connection with a preset device when a preset trigger condition is detected. The method also includes starting an automatic detection program to obtain an automatic detection result. The method further includes sending the automatic detection result to the preset device.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart showing a method for testing a terminal according to an exemplary embodiment;

FIG. 2 is a flowchart showing a method for testing a terminal according to another exemplary embodiment;

FIG. 3 is a flowchart showing a method for testing a terminal according to another exemplary embodiment;

FIG. 4 is a flowchart showing a method for testing a terminal according to another exemplary embodiment;

FIG. 5 is a block diagram of a device for testing a terminal according to an exemplary embodiment;

FIG. 6 is a block diagram of a device for testing a terminal according to another exemplary embodiment;

FIG. 7 is a block diagram of a device for testing a terminal according to another exemplary embodiment;

FIG. 8 is a block diagram of a device for testing a terminal according to another exemplary embodiment;

FIG. 9 is a block diagram of a device for testing a terminal according to another exemplary embodiment;

FIG. 10 is a block diagram of a device for testing a terminal according to another exemplary embodiment; and

FIG. 11 is a block diagram of a device for testing a terminal according to another exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

With the development of computer technology and wireless communication technology, more and more electronic devices are equipped with a wireless communication module. For example, many smart mobile phones and tablet computers have wireless communication capabilities. Wireless communication technology is also widely used in the field of smart terminals, smart homes, etc. Before an electronic device is delivered by a manufacturer, a test technician typically tests the hardware and software components of the electronic device, so as to ensure that the electronic device functions normally. An electronic device serves as an exemplary device under test in the embodiments of the present disclosure.

In related art, a test technician needs to manually start an automatic detection program for each device under test. After the automatic detection of the device under test is completed, the test technician sends an automatic detection result to a test host via a manual operation. If ten devices under test need an automatic detection, the test technician needs to conduct ten corresponding operations, which results in a waste of time for the test technician. Moreover, an actual number of devices under test is much larger than ten. Therefore, the test technician needs to spend a lot of time in starting the automatic detection programs and sending automatic detection results. The test technician also needs to process each of the automatic detection results received by the test host. Therefore, the testing efficiency of the devices is low.

An embodiment of the present disclosure provides a method for testing a terminal or a device. By means of a preset trigger condition, a connection between the terminal and a preset device is confirmed. After the connection with the preset device is established, an automatic detection program is started, and an automatic detection result is sent to the preset device. Before a device is delivered by the manufacturer, an automatic detection program of the device under test needs to be started. In a conventional process of starting the automatic detection program, each device under test needs to be manually started by a test technician. Thus, multiple operations by the test technician are needed. In the disclosed embodiments, the automatic detection program of the device under test is started automatically when the preset trigger condition is satisfied, which allows for simultaneously starting the automatic detection programs on multiple devices under test. This improves the testing efficiency. Moreover, multiple devices under test can simultaneously send the automatic detection results to the preset device, which facilitates recording of the test results.

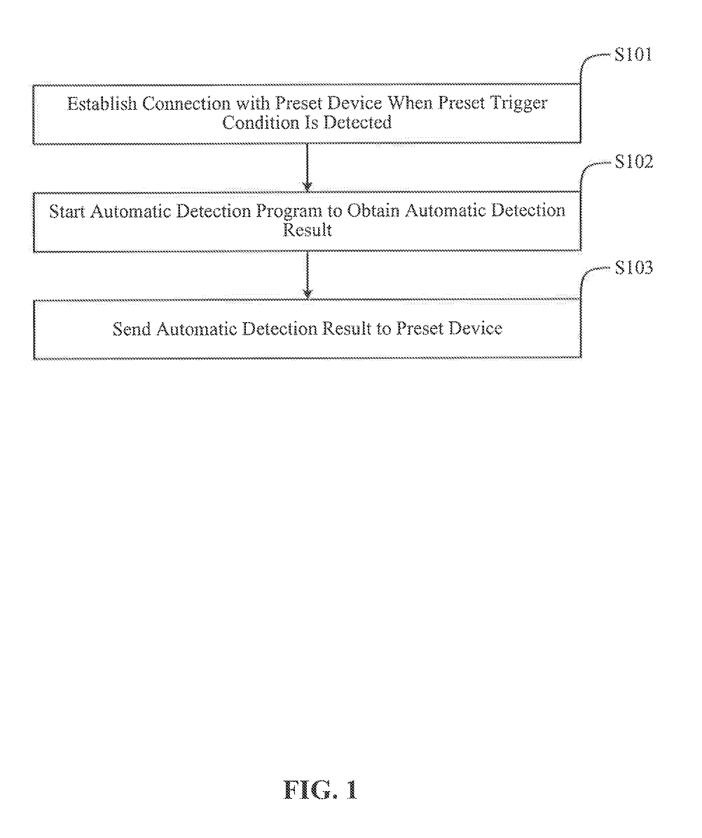

FIG. 1 is a flowchart showing a method for testing a terminal according to an exemplary embodiment. As shown in FIG. 1, the method for testing a terminal is implemented by a device under test. The method includes the following steps.

In Step S101, when a preset trigger condition is detected, a connection with a preset device is established. For example, the connection between the device under test and the preset device can be established by at least one of a WiFi (a wireless network technology) connection, a Bluetooth connection, and an NFC (Near Field Communication) connection. When one or more of these three connection techniques are used for connecting the device under test and the preset device, the automatic detection results can be transferred to the preset device using the one or more of these three connection techniques. In addition, one or more functional modules provided in the device under test corresponding to the one or more of these three connection techniques can be tested for their operating status (e.g., whether they work properly). This can be performed as part of the automatic detection. Thus, a separate automatic detection is not needed for detecting the operating status of the functional modules corresponding to the three connection techniques, thereby improving the testing efficiency.

In Step S102, an automatic detection program is started to obtain an automatic detection result.

In Step S103, the automatic detection result is sent to the preset device.

An embodiment of the present disclosure provides a method for testing a terminal. By presetting a trigger condition, a connection with a preset device is confirmed. After the connection with the preset device is established, an automatic detection program is started, and an automatic detection result is sent to the preset device. Before a device is delivered by the manufacturer, an automatic detection program of the device under test needs to be started. In a conventional process of starting the automatic detection program, each device under test needs to be manually started by a test technician. Thus multiple operations by the test technician are needed. In the disclosed embodiments, the automatic detection program of the device under test is automatically started when the preset trigger condition is satisfied, which allows for simultaneously starting the automatic detection programs on multiple devices under test. This improves the efficiency in testing the devices before the devices are delivered by the manufacturer. Moreover, multiple devices under test can simultaneously send the automatic detection results to the preset device, which facilitates recording the test results.

In an embodiment, Step S101 may also be implemented as follows: a connection with a preset device is established according to a preset identifier and a preset password when preset input operation information is detected.

For example, the preset identifier is a hardware identifier of a preset device, such as an SSID (Service Set Identifier), or a MAC (Media Access Control) address, etc. Each preset device has a different hardware identifier. Therefore, a preset device may be accurately determined using a hardware identifier of the preset device as a preset identifier.

With the foregoing disclosed method, when preset input operation information is detected, a connection with the preset device is established according to a preset identifier and a preset password. In the disclosed method, the preset input operation information serves as a preset trigger condition. With the preset input operation, the operations performed by a test technician are simplified, thereby improving the testing efficiency.

In an embodiment, detecting a preset trigger condition includes detecting a network device having a preset identifier. The preset device includes the network device having the preset identifier. Step S101 can also be implemented as Step A1-Step A2.

In Step A1, the network device in the current network is detected.

In Step A2, when detecting a network device having a preset identifier, a connection with the network device having the preset identifier is established according to a preset password corresponding to the preset identifier.

For example, the device under test is an electronic device having a WiFi (a wireless network technology) function, such as a mobile phone, a tablet computer, a smart home device, or the like. It is a basic function of the device under test to automatically detect a network device in the current environment. The device under test can detect a network device in the environment in real time. If the device under test detects the existence of a network device having the preset identifier in the environment, a connection with the network device is established, and then an automatic detection program is started.

With the foregoing disclosed method, when the preset trigger condition is detection of a network device having a preset identifier, the detection of the network device in the current network is automatically conducted by a device under test, without requiring a manual search by a test technician. When the device under test is being tested, the device under test is placed, e.g., by the test technician, in a network environment that includes the network device having the preset identifier. In this way, an automatic detection program of the device under test is automatically started after detecting the network device having the preset identifier, thereby improving the test efficiency.

In an embodiment, Step S103 can also be implemented as: Step B1-Step B2.

In Step B1, a detection log is generated according to the automatic detection result.

In Step B2, the detection log is sent to the preset device.

With the foregoing disclosed method, an automatic detection result is sent to the preset device in the form of a detection log, which facilitates data transmission of the automatic detection result. In addition, the detection log makes it convenient for the test technician to search and review the automatic detection result on the preset device, thereby improving the test efficiency.

In an embodiment, the preset device includes a network access device. When the preset device is the network access device, Step B2 can also be implemented as Step C1. In Step C1, a detection log is sent to the network access device, and the network access device is instructed to transfer the detection log to a test host.

In some embodiments, the preset device includes the network access device and/or the test host. For example, the device under test can either be directly connected to the test host or be connected to the test host via the network access device. When the preset device is the test host, Step B2 includes sending the detection log to the test host. The test host may not be the only test device, since multiple test hosts can exist. In related art, when the device under test sends a detection log to at least two test hosts, the device under test needs to send data of the detection log at least twice, or send the detection log once to only one of the test hosts. No matter which one of the foregoing manners is used for sending the detection log, it is difficult to ensure both an efficiency of recording the test hosts and an efficiency of transmitting the detection log simultaneously.

With the foregoing disclosed method, when the preset device is a network access device, the detection log is transferred by the device under test to a test host via the network access device, allowing the preset device to transfer the detection log to one or more test hosts. This facilitates data acquisition of the detection logs from the devices under test by the test hosts, thereby facilitating recording of the test results provided by the devices under test.

In an embodiment, when the preset device is the network access device, after Step S101, the method further includes step D1. In Step D1, a wake-up message is sent to the network access device, and the network access device is instructed to transfer the wake-up message to a test host, so that the test host enters a working state according to the wake-up message.

Alternatively or additionally, step C1 discussed above may also include: after sending a wake-up message to the network access device, sending a detection log to the network access device, and instructing the network access device to transfer the detection log to the test host.

With the foregoing disclosed method, after a connection with the preset device is established, a wake-up message is sent to the network access device, so that the test host enters a working state. After the wake-up message is sent to the network access device, a detection log is sent to the network access device, and is transferred via the network access device to the test host. As a result, the test host can enter a sleep state when it is not in the working state, thereby reducing resource consumption in the test host. When the test host is in the sleep state, the test host can still quickly restore to access the detection log transferred by the network access device, thereby improving the test efficiency.

The methods provided in the present disclosure are described with reference to the following embodiments.

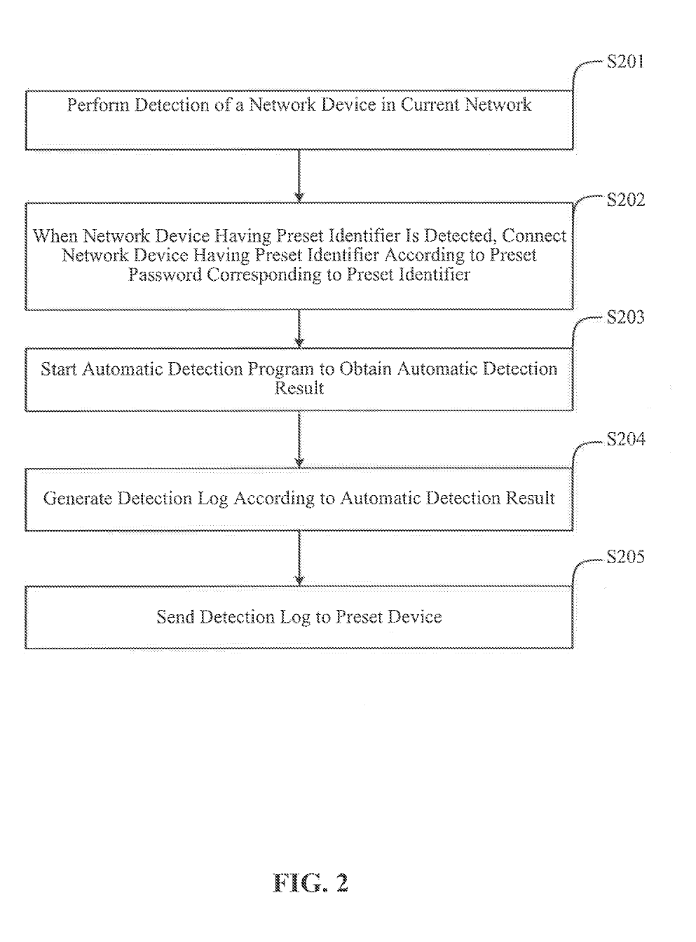

FIG. 2 is a flowchart showing a method for testing a terminal according to another exemplary embodiment. In the method shown in FIG. 2, a preset device is a test host. The method includes the following steps.

In Step S201, a detection of a network device in the current network is performed.

For example, a detection is performed to determine whether a network device with a username “test device” is present in the current network.

In Step S202, when a network device having a preset identifier is detected, a connection with the network device having the preset identifier is established according to a preset password corresponding to the preset identifier.

When the preset identifier is “test device,” the username of the network device in the network is the same as a preset username. A connection with the network device whose username is “test device” is established according to a preset password corresponding to the preset identifier.

In Step S203, an automatic detection program is started to obtain an automatic detection result.

After a connection with the network device whose username is “test device” is established, the device under test starts a local automatic detection program and obtains an automatic detection result.

In Step S204, a detection log is generated according to the automatic detection result.

In Step S205, the detection log is sent to the preset device.

An embodiment of the present disclosure provides a method for testing a terminal. When the preset trigger condition is detection of a network device having a preset identifier, detection of the network device in the current network is automatically performed by a device under test. As a result, a manual search by a test technician is not required. When the device under test is being tested, the device under test is placed, by the test technician, in a network environment including the network device having a preset identifier. In this way, an automatic detection program of the device under test can be started, thereby improving the test efficiency. When only one network device exists in the network, the device under test is in a test site associated with the only one network device. This avoids the situation in which the device under test starts the automatic detection program in a non-test site where a network device having a username that is the same as the preset identifier exists. An automatic detection result is sent to the preset device in the form of a detection log, which facilitates data transmission of the automatic detection result. The detection log also makes it convenient for the test technician to search and review the automatic detection result on the preset device, thereby improving the test efficiency.

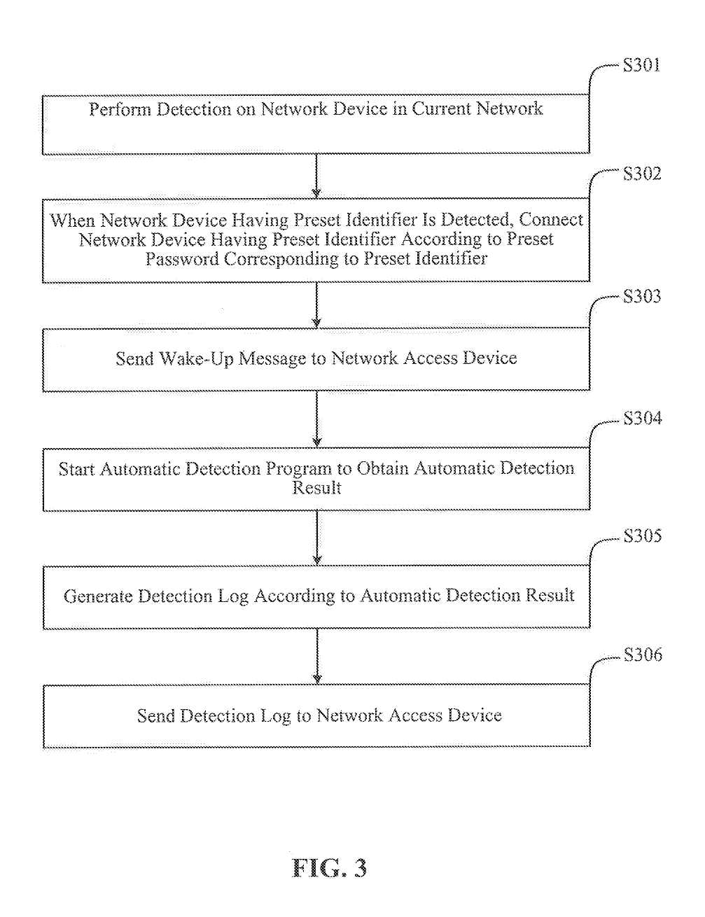

FIG. 3 is a flowchart showing a method for testing a terminal according to another exemplary embodiment. As shown in FIG. 3, in the method for testing a terminal, the preset device is a network access device, such as a router. The method includes the following steps.

In Step S301, a detection of a network device in the current network is performed.

A detection is performed to determine whether in the current network, a network device with username “test device” is present.

In Step S302, when a network device having a preset identifier is detected, a connection with the network device having the preset identifier is established according to a preset password corresponding to the preset identifier.

For example, when the preset identifier is “test device,” the username of the router in the network is the same as a preset username. A connection with the router whose username is “test device” is established according to a preset password corresponding to the preset identifier.

In Step S303, a wake-up message is sent to the network access device, and the network access device is instructed to transfer the wake-up message to a test host, so that the test host enters a working state according to the wake-up message.

A wake-up message is sent to the router whose username is “test device.” The test host is in a sleep state when it is not in a working state, which may reduce power consumption in the test host, and reduce the effect on the service life of the test host due to long time operations. Therefore, after a connection with the router is established, a wake-up message is sent to the test host via the router. The wake-up message enables the test host to wake up from the sleep state and enter into the working state.

In Step 304, an automatic detection program is started to obtain an automatic detection result.

In Step 305, a detection log is generated according to the automatic detection result.

In Step 306, the detection log is sent to a network access device, and the network access device is instructed to transfer the detection log to the test host.

An embodiment of the present disclosure provides a method for testing a terminal. When the preset device is the network access device, a detection log is transferred by the device under test to the test host via the network access device. As a result, the detection log is transferred by the preset device to one or multiple test hosts, which facilitates data acquisition of the detection log from the device under test by the test hosts. Moreover, the disclosed methods facilitate recording of the test results provided by the devices under test. After the connection with a network access device is established, a wake-up message is sent to the network access device. The wake-up message is transferred to the test host via the network access device, so that the test host enters a working state. After the wake-up message is sent to the network access device, a detection log is sent to the network access device, and is transferred to the test host via the network access device. As a result, the test host enters a sleep state when it is not in the working state, thereby reducing resource consumption in the test host. When the test host is in the sleep state, the test host can still quickly restore to access the detection log transferred via the network access device, thereby improving the test efficiency.

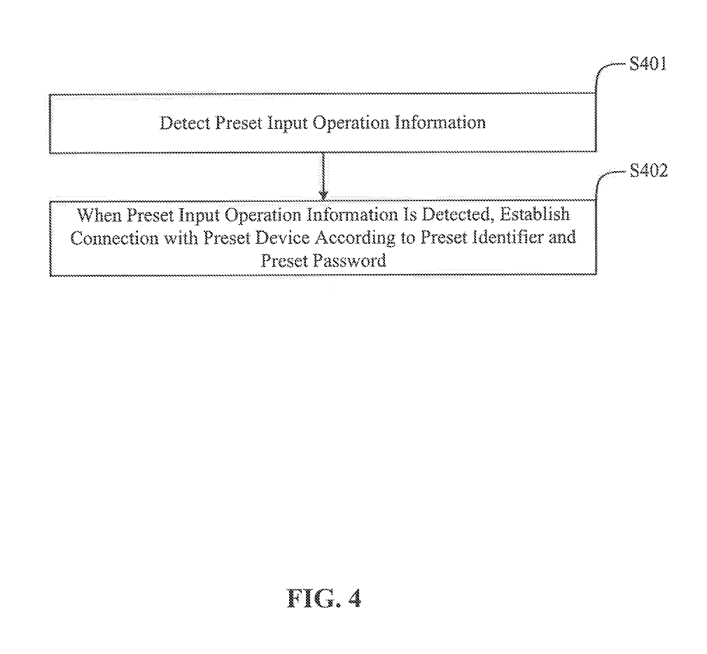

The disclosed method for testing a terminal can be implemented using the above technical solutions. In the disclosed method, a connection between a device under test and a preset device can be established according to the following technical solution discussed in connection with FIG. 4.

FIG. 4 is a flowchart showing a method for testing a terminal according to another exemplary embodiment. The method shown in FIG. 4 includes the following steps.

In Step S401, a detection of preset input operation information is performed.

A preset input operation can be either an operation, by the test technician, of pressing a special combination of keys on the device, or a special input through a device interface, as long as the preset input operation is an operation that is infrequently used by a user (e.g., the test technician) or other operators.

In Step S402, when preset input operation information is detected, a connection with the preset device is established according to a preset identifier and a preset password.

When the device under test is manufactured, a preset identifier and a preset password are set in the device under test in advance. The preset identifier is a hardware identifier of the preset device. When the device under test detects preset input operation information, the device under test connects to the preset device corresponding to the preset identifier. After the connection is established, an automatic detection is performed on the device under test, and an automatic detection result is sent by the device under test to the preset device.

An embodiment of the present disclosure provides a method for connecting the preset device that can be included in the method for testing a terminal. When preset input operation information is detected, a connection with the preset device is established according to a preset identifier and a preset password. The preset input operation information serves as a preset trigger condition, and the preset input operation is convenient for the test technician to perform. As a result, the disclosed method improves the test efficiency.

The following are embodiments of a device according to the present disclosure, which is configured to carry out the disclosed methods.

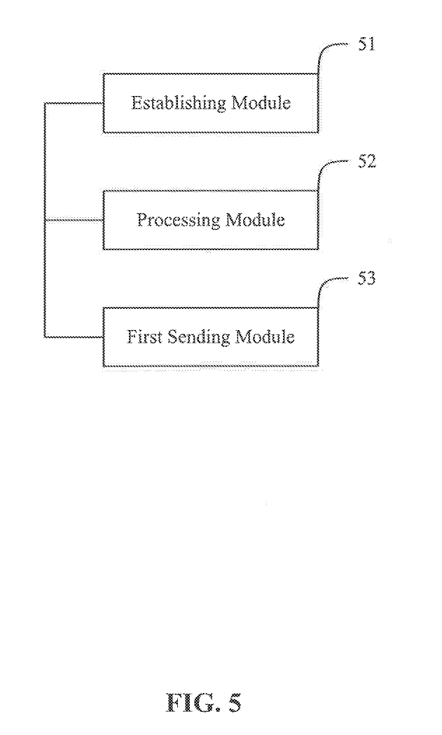

FIG. 5 is a block diagram of a device for testing a terminal according to an exemplary embodiment. The device is implemented as an electronic device in part or in whole by means of software and hardware or a combination of both. As shown in FIG. 5, the device for testing a terminal included as part of a device under test includes an establishing module 51 configured to establish a connection with a preset device when a preset trigger condition is detected. The device for testing a terminal also includes a processing module 52 configured to start an automatic detection program to obtain an automatic detection result. The device for testing a terminal further includes a first sending module 53 configured to send the automatic detection result to the preset device.

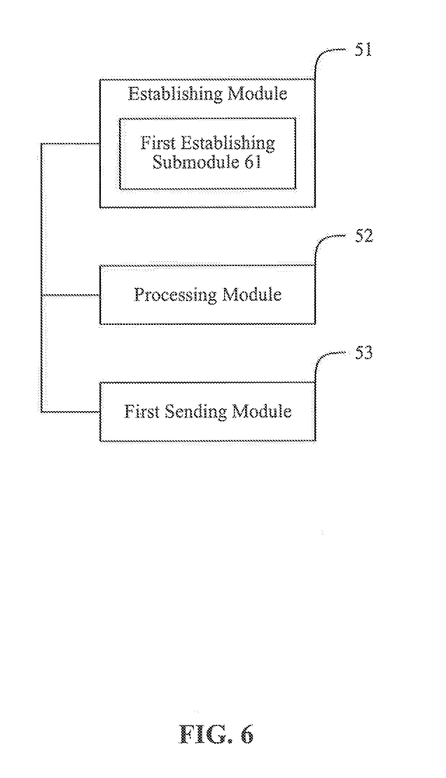

FIG. 6 is a block diagram of a device for testing a terminal according to another exemplary embodiment. As shown in FIG. 6, the establishing module 51 includes a first establishing submodule 61 configured to establish a connection with the preset device according to a preset identifier and a preset password when preset input operation information is detected.

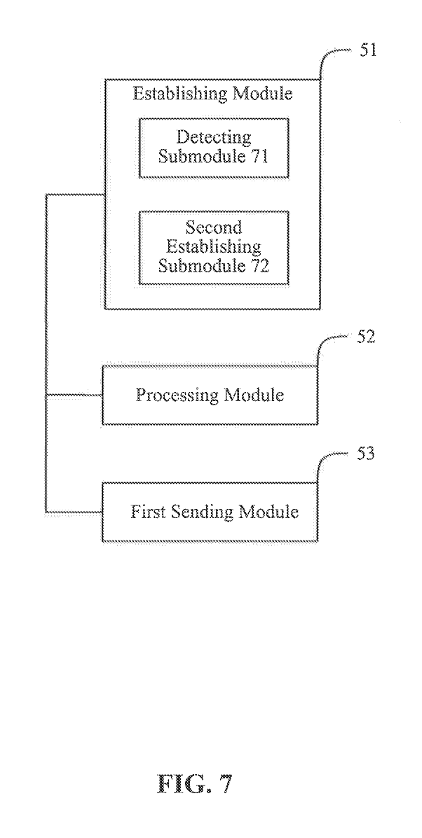

FIG. 7 is a block diagram of a device for testing a terminal according to another exemplary embodiment. In the disclosed methods discussed above, in some embodiments, detecting a preset trigger condition includes detecting a network device having a preset identifier. The preset device includes the network device having the preset identifier. As shown in FIG. 7, the establishing module 51 includes a detecting submodule 71 configured to detect the network device in the current network. The establishing module 51 also includes a second establishing submodule 72. When a network device having the preset identifier is detected, the second establishing submodule 72 is configured to establish a connection with the network device having the preset identifier according to a preset password corresponding to the preset identifier, thereby establishing a connection with the preset device.

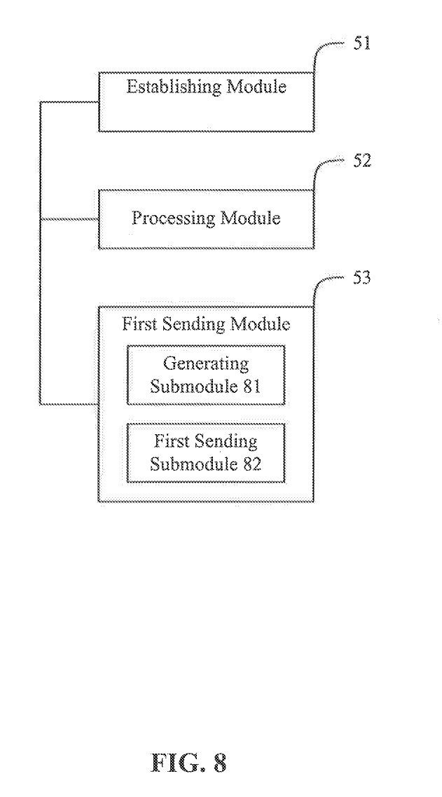

FIG. 8 is a block diagram of a device for testing a terminal according to another exemplary embodiment. As shown in FIG. 8, the first sending module 53 includes a generating submodule 81 configured to generate a detection log according to the automatic detection result. The first sending module 53 also includes a first sending submodule 82 configured to send the detection log to the preset device.

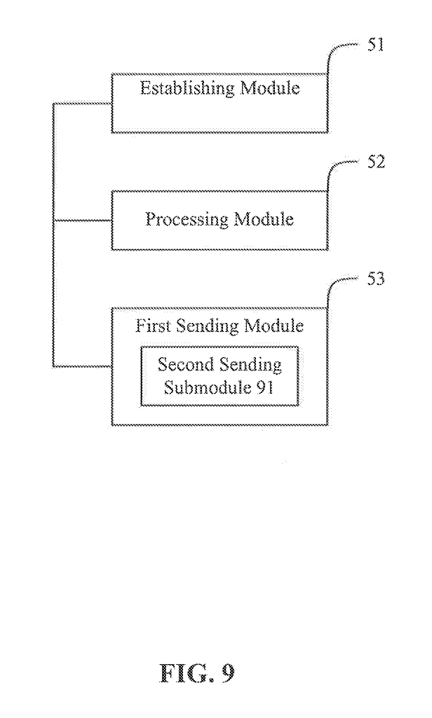

FIG. 9 is a block diagram of a device for testing a terminal according to another exemplary embodiment. In some embodiments, the preset device includes a network access device. When the preset device is the network access device, the first sending module 53 includes, as shown in FIG. 9, a second sending submodule 91 configured to send the detection log to the network access device, and instruct the network access device to transfer the detection log to a test host.

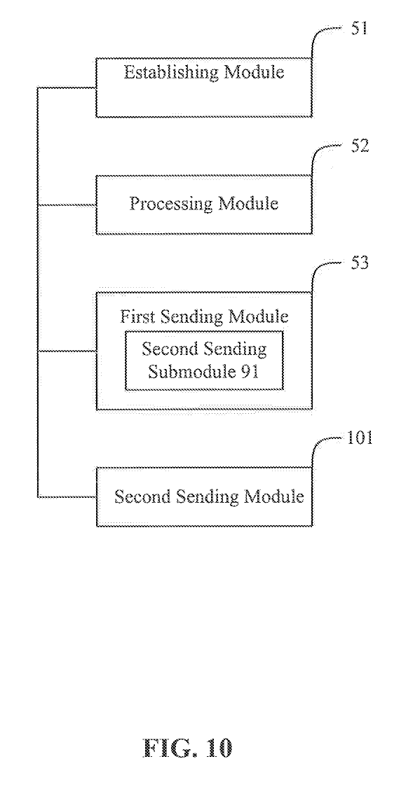

FIG. 10 is a block diagram of a device for testing a terminal according to another exemplary embodiment. As shown in FIG. 10, the device further includes a second sending module 101 configured to send a wake-up message to the network access device, and instruct the network access device to transfer the wake-up message to the test host, so that the test host enters a working state according to the wake-up message.

The second sending submodule 91 shown in FIG. 9 is further configured to send, after sending a wake-up message to the network access device, a detection log to the network access device, and instruct the network access device to transfer the detection log to the test host.

Embodiments of the present disclosure include a device for testing a terminal. The device includes a processor, and a memory configured to store instructions executable by the processor. The processor is configured to establish a connection with a preset device when a preset trigger condition is detected, start an automatic detection program to obtain an automatic detection result, and send the automatic detection result to the preset device.

In some embodiments, the processor is also configured to establish a connection with the preset device when a preset trigger condition is detected. The processor is further configured to detect preset input operation information, and establish a connection with the preset device according to a preset identifier and a preset password.

In some embodiments, detecting a preset trigger condition includes detecting a network device having a preset identifier. In some embodiments, the preset device includes the network device having the preset identifier. In some embodiments, establishing a connection with the preset device when a preset trigger condition is detected includes performing a detection of the network device in the current network, and when the network device having the preset identifier is detected, establishing a connection with the network device having the preset identifier according to a preset password corresponding to the preset identifier.

In some embodiments, the processor is also configured to send an automatic detection result to the preset device. In some embodiments, the processor is configured to generate a detection log according to the automatic detection result, and send the detection log to the preset device.

In some embodiments, the preset device includes a network access device. In some embodiments, the processor is also configured to send, when the preset device is the network access device, the detection log to the preset device. The processor is configured to send the detection log to the network access device, and instruct the network access device to transfer the detection log to a test host.

In some embodiments, the preset device is the network access device. In some embodiments, after establishing a connection with a preset device, the processor is further configured to send a wake-up message to the network access device, and instruct the network access device to transfer the wake-up message to the test host, so that the test host enters a working state according to the wake-up message.

In some embodiments, sending the detection log to the network access device, and instructing the network access device to transfer the detection log to a test host include: after sending the wake-up message to the network access device, sending the detection log to the network access device, and instructing the network access device to transfer the detection log to the test host.

With regard to the embodiments of the disclosed device, detailed descriptions of operations performed by the modules have been provided in the descriptions of the embodiments of the disclosed methods. Thus, the detailed descriptions of the operations performed by the modules are not repeated.

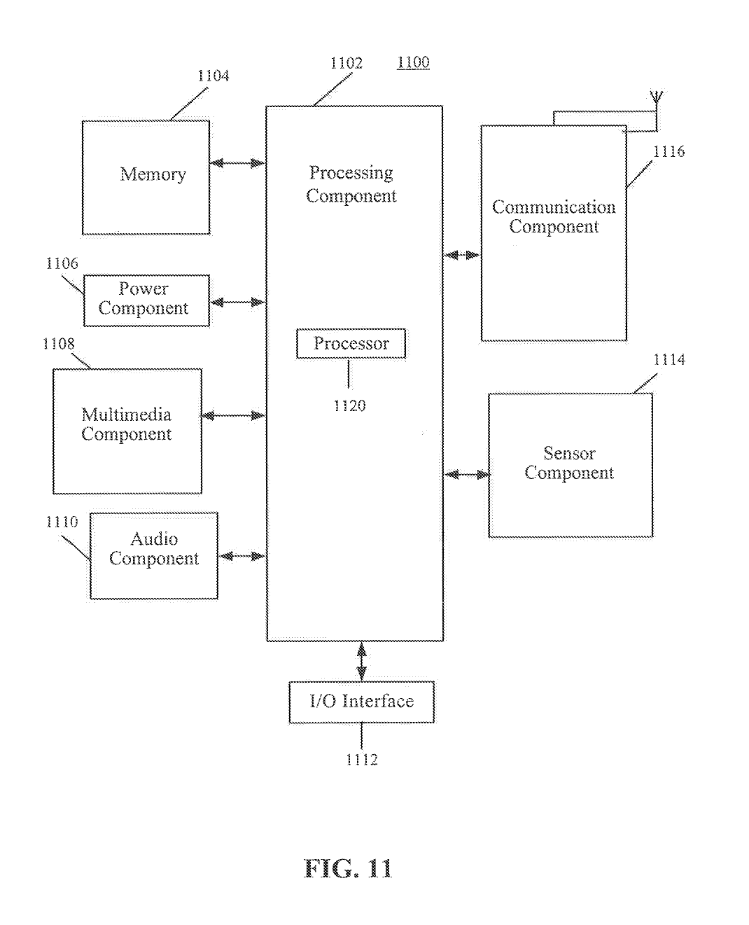

FIG. 11 is a block diagram of a device 1100 for testing a terminal according to another exemplary embodiment. The device can be included as a part of a terminal device. For example, the device 1100 can be a mobile telephone, a computer, a digital broadcasting terminal, a message transceiver device, a games console, a tablet device, a medical device, a fitness facility, a personal digital assistant, and the like.

The device 1100 includes one or more of the following components: a processing component 1102, a memory 1104, a power supply component 1106, a multimedia component 1108, an audio component 1110, an input/output (I/O) interface 1112, a sensor component 1114, and a communication component 1116.

The processing component 1102 is configured to control overall operations of the device 1100, such as the operations associated with display, telephone calls, and data communications, camera operations, and recording operations. The processing component 1102 includes one or more processors 1120 configured to execute instructions stored in the memory 1104 to perform all or portions of the above described methods. Moreover, the processing component 1102 includes one or more modules that facilitate the interaction between the processing component 1102 and other components. For instance, the processing component 1102 includes a multimedia module configured to facilitate the interaction between the multimedia component 1108 and the processing component 1102.

The memory 1104 is configured to store various types of data to support the operation of the device 1100. Examples of such data include instructions for any applications or methods executed or performed by the device 1100, contact data, phonebook data, messages, pictures, video, etc. The memory 1104 is implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 is configured to provide power to various components of the device 1100. The power component 1106 includes a power management system, one or more power sources, and any other components associated with the generation, management, and distribution of power in the device 1100.

The multimedia component 1108 includes a screen providing an output interface between the device 1100 and the user. In some embodiments, the screen includes at least one of a liquid crystal display (LCD) and a touch panel (TP). If the screen includes the touch panel, the screen is implemented as a touch screen to receive input signals from the user. The touch panel includes one or more touch sensors to sense touches, swipes, and gestures on the touch panel. The touch sensors not only senses a boundary of a touch or swipe action, but also senses a period of time and a pressure associated with the touch or swipe action. In some embodiments, the multimedia component 1108 includes a front camera and/or a rear camera. The front camera and the rear camera receive external multimedia data while the device 1100 is in an operation mode, such as a photographing mode or a video mode. Each of the front camera and the rear camera has a fixed optical lens system or has focus and optical zoom capability.

The audio component 1110 is configured to output and/or input audio signals. For example, the audio component 1110 includes a microphone configured to receive an external audio signal when the device 1100 is in an operation mode, such as a call mode, a recording mode, and a voice recognition mode. The received audio signal can be stored in the memory 1104 or transmitted via the communication component 1116. In some embodiments, the audio component 1110 further includes a speaker configured to output audio signals.

The I/O interface 1112 provides an interface between the processing component 1102 and peripheral interface modules, such as a keyboard, a click wheel, buttons, and the like. The buttons include, but are not limited to, a home button, a volume button, a starting button, and a locking button.

The sensor component 1114 includes one or more sensors configured to provide status assessments of various aspects of the device 1100. For example, the sensor component 1114 detects open/closed statuses of the device 1100, and relative positioning of components, such as the display and the keypad. In some embodiments, the sensor component 1114 also detects position changes of the device 1100 or its components, presence or absence of user contacts with the device 1100, orientation or acceleration/deceleration of the device 1100, and temperature changes of the device 1100. The sensor component 1114 further includes a proximity sensor configured to detect the presence of nearby objects without any physical contact. In some embodiments, the sensor component 1114 includes a light sensor, such as a CMOS or CCD image sensor, for use in imaging applications. In some embodiments, the sensor component 1114 also includes at least one of an acceleration sensor, a gyroscope sensor, a magnetic sensor, a pressure sensor, or a temperature sensor.

The communication component 1116 is configured to facilitate wired or wireless communication between the device 1100 and other devices. The device 1100 accesses a wireless network based on a communication standard, such as WiFi, 2G, 3G, or a combination thereof. In an exemplary embodiment, the communication component 1116 receives a broadcast signal or broadcast related information from an external broadcast management system via a broadcast channel. In an exemplary embodiment, the communication component 1116 further includes a near-field communication (NFC) module to facilitate short-range communications. The NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1100 is implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium storing instructions, such as those stored in the memory 1104, which are executable by the processor 1120 included in the device 1100, for performing the above-described methods. For example, the non-transitory computer-readable storage medium can be a ROM, a random access memory (RAM), a CD-ROM, a magnetic tape, a floppy disc, an optical data storage device, and the like.

The present disclosure also provides a non-transitory computer-readable storage medium storing instruction that, when executed by the processor of the device 1100, enable the device 1100 to perform the disclosed method for testing a terminal. The method includes establishing a connection with a preset device when a preset trigger condition is detected, starting an automatic detection program to obtain an automatic detection result, and sending the automatic detection result to the preset device.

In some embodiments of the method, establishing a connection with the preset device when a preset trigger condition is detected includes detecting preset input operation information, and establishing a connection with the preset device according to a preset identifier and a preset password.

In some embodiments of the method, detecting a preset trigger condition includes detecting a network device having a preset identifier. In some embodiments, the preset device includes the network device having the preset identifier.

In some embodiments of the disclosed method, establishing a connection with a preset device when a preset trigger condition is detected includes detecting the network device in a current network, and when the network device having a preset identifier is detected, establishing a connection with the network device having a preset identifier according to a preset password corresponding to the preset identifier.

In some embodiments of the disclosed method, sending an automatic detection result to the preset device includes generating a detection log according to the automatic detection result, and sending the detection log to the preset device.

In some embodiments, the preset device includes a network access device. In some embodiments of the disclosed method, when the preset device is the network access device, sending the detection log to the preset device includes sending the detection log to the network access device, and instructing the network access device to transfer the detection log to a test host.

In some embodiments, when the preset device is the network access device, after establishing a connection with the preset device, the disclosed method further includes sending a wake-up message to the network access device, and instructing the network access device to transfer the wake-up message to the test host, so that the test host enters a working state according to the wake-up message.

In some embodiments of the disclosed method, sending the detection log to the network access device, and instructing the network access device to transfer the detection log to a test host include: after sending a wake-up message to the network access device, sending the detection log to the network access device, and instructing the network access device to transfer the detection log to the test host.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for testing a terminal, for use in a device under test, comprising:
establishing a connection with a preset device when a preset trigger condition is detected;
starting an automatic detection program to obtain an automatic detection result; and
sending the automatic detection result to the preset device.

2. The method of claim 1, wherein establishing the connection with the preset device when the preset trigger condition is detected includes:
detecting preset input operation information; and
establishing the connection with the preset device according to a preset identifier and a preset password.

3. The method of claim 1, wherein detecting the preset trigger condition includes:
detecting a network device having a preset identifier,
wherein the preset device includes the network device having the preset identifier, and
wherein establishing the connection with the preset device when the preset trigger condition is detected includes:
detecting the network device in a current network; and
when the network device having the preset identifier is detected, establishing a connection with the network device having the preset identifier according to a preset password corresponding to the preset identifier.

4. The method of claim 1, wherein sending the automatic detection result to the preset device includes:
generating a detection log according to the automatic detection result; and
sending the detection log to the preset device.

5. The method of claim 4, wherein the preset device includes a network access device,
wherein when the preset device is the network access device, sending the detection log to the preset device includes sending the detection log to the network access device, and instructing the network access device to transfer the detection log to a test host.

6. The method of claim 5, after the establishing the connection with the preset device, the method further includes:
sending a wake-up message to the network access device, and instructing the network access device to transfer the wake-up message to the test host, so that the test host enters a working state according to the wake-up message,
wherein sending the detection log to the network access device, and instructing the network access device to transfer the detection log to the test host includes:
after sending the wake-up message to the network access device, sending the detection log to the network access device, and instructing the network access device to transfer the detection log to the test host.

7. A device for testing a terminal, which is for use in a device under test, comprising:
a processor; and
a memory configured to store instructions executable by the processor,
wherein the processor is configured to execute the instructions to:
establish a connection with a preset device when a preset trigger condition is detected;
start an automatic detection program to obtain an automatic detection result; and
send the automatic detection result to the preset device.

8. The device of claim 7, wherein the processor is further configured to execute the instructions to:
detect preset input operation information; and
establish the connection with the preset device according to a preset identifier and a preset password.

9. The device of claim 7,
wherein detecting the preset trigger condition includes detecting a network device having a preset identifier, wherein the preset device includes the network device having the preset identifier, and
wherein the processor is further configured to execute the instructions to:
detect the network device in a current network; and
when the network device having the preset identifier is detected, establish a connection with the network device having the preset identifier according to a preset password corresponding to the preset identifier.

10. The device of claim 7, wherein the processor is further configured to execute the instructions to:
generate a detection log according to the automatic detection result; and
send the detection log to the preset device.

11. The device of claim 10, wherein the preset device includes a network access device,
wherein when the preset device is the network access device, the processor is further configured to execute the instructions to:
send the detection log to the network access device, and instruct the network access device to transfer the detection log to a test host.

12. The device of claim 11, wherein when the preset device is the network access device, after establishing the connection with the preset device, the processor is further configured to execute the instructions to:
send a wake-up message to the network access device, and instruct the network access device to transfer the wake-up message to the test host, so that the test host enters a working state according to the wake-up message; and
after sending the wake-up message to the network access device, send the detection log to the network access device, and instruct the network access device to transfer the detection log to the test host.

13. A non-transitory computer readable storage medium having stored therein instructions that, when executed by a processor of a device under test, cause the device under test to perform a method for testing a terminal, the method comprising:
establishing a connection with a preset device when a preset trigger condition is detected;
starting an automatic detection program to obtain an automatic detection result; and
sending the automatic detection result to the preset device.

14. The non-transitory computer readable storage medium of claim 13, wherein establishing the connection with the preset device when the preset trigger condition is detected includes detecting preset input operation information, and establishing the connection with the preset device according to a preset identifier and a preset password.

15. The non-transitory computer readable storage medium of claim 13,
wherein detecting a preset trigger condition includes detecting a network device having a preset identifier, wherein the preset device includes the network device having the preset identifier, and
wherein establishing the connection with the preset device when the preset trigger condition is detected includes:
detecting the network device in a current network; and
when the network device having a preset identifier is detected, establishing a connection with the network device having the preset identifier according to a preset password corresponding to the preset identifier.

16. The non-transitory computer readable storage medium of claim 13, wherein sending the automatic detection result to the preset device includes:
generating a detection log according to the automatic detection result; and
sending the detection log to the preset device.

17. The non-transitory computer readable storage medium of claim 16, wherein the preset device includes a network access device;
wherein when the preset device is the network access device, sending the detection log to the preset device includes sending the detection log to the network access device, and instructing the network access device to transfer the detection log to a test host.

18. The non-transitory computer readable storage medium of claim 17, wherein when the preset device is the network access device, after the establishing the connection with the preset device, the method further includes:
sending a wake-up message to the network access device, and instructing the network access device to transfer the wake-up message to the test host, so that the test host enters a working state according to the wake-up message,
wherein sending the detection log to the network access device, and instructing the network access device to transfer the detection log to the test host include:
after sending the wake-up message to the network access device, sending the detection log to the network access device, and instructing the network access device to transfer the detection log to the test host.
